(19) United States
(12) Patent Application Publication
(10) Pub. No.: US 2023/0290336 A1
(43) Pub. Date: Sep. 14, 2023

(54) SPEECH RECOGNITION SYSTEM AND METHOD FOR AUTOMATICALLY CALIBRATING DATA LABEL

(71) Applicant: IUCF-HYU (INDUSTRY-UNIVERSITY COOPERATION FOUNDATION HANYANG UNIVERSITY), Seoul (KR)

(72) Inventors: Joon-Hyuk CHANG, Seoul (KR); Jaehong LEE, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 18/040,381

(22) PCT Filed: Jul. 19, 2021
(86) PCT No.: PCT/KR2021/009250

§ 371 Date: Feb. 2, 2023

(30) Foreign Application Priority Data
Aug. 3, 2020 (KR) 10-2020-0096923

(51) Int. Cl. G10L 15/06

(52) U.S. Cl. CPC G10L 15/063

(57) ABSTRACT

Proposed are a speech recognition system and method for automatically calibrating a data label. A speech recognition method for automatically calibrating a data label according to an embodiment may comprise the steps of: performing confidence-based filtering to find the location of occurrence of a wrong label in time-series speech data, in which a correct label and the wrong label are temporally mixed, by using a transformer-based speech recognition model; and after performing filtering, replacing a label at a decoder time step, which has been determined to be a wrong label by the location of occurrence of the wrong label, so as to improve the performance of the transformer-based speech recognition model, wherein the step of performing confidence-based filtering to find the location of occurrence of the wrong label in the time-series speech data comprises finding and calibrating the wrong label using the confidence obtained by using a transition probability between labels at every decoder time step.

### TECHNICAL FIELD

The following embodiments relate to a speech recognition system and method for automatically correcting a data label, and more particularly, to a system and method for automatically correcting an incorrect label, among labels that are answers of data, in speech recognition for speech recognition.

### Background Art

A transformer-based time-series model is a model that maps two time series having different lengths by using an attention mechanism. A structure of this model includes an encoder that changes speech time series into memory and a decoder that predicts a current label by using the memory and the past labels. In particular, two types of attention alignment in which a speech or a relation between labels is considered and an attention network for finding to which part of the memory a current label is mapped are used.

As a conventional technology, a method of excluding noisy data from learning is basically used in an automatic correction system in “Han, B., Yao, Q., Yu, X., Niu, G., Xu, M., Hu, W., Tsang, I., Sugiyama, M.: Co-teaching: Robust training of deep neural networks with extremely noisy labels. In NeurIPS. (2018)”, “Jiang, L., Zhou, Z., Leung, T., Li, L. J., Fei-Fei, L.: Mentornet: Learning data-driven curriculum for very deep neural networks on corrupted labels. In ICML. (2018)”, “Zhang, Z., Sabuncu, M.: Generalized cross entropy loss for training deep neural networks with noisy labels. In NeurIPS. (2018)”, etc. In this case, there was proposed a method of selecting data to be used by a counterpart model on the basis of data having a small loss by using two models having the same structure and transferring the data. In the same way, there was research in which the two models are used, but one model becomes a mentor and functions to provide an answer to be used in another student model, but this has a weakness in that a ratio of corrupted labels is sensitively increased depending on performance of the mentor model. Unlike this, there is also a method of filtering using confidence of a model that is obtained by using a loss function robust against corrupted labels and a fixed threshold value.

In the existing method, given data is learnt through supervised learning. In this case, essential labels are commonly corrupted. This basically occurs when a non-specialist produces labels for data. Such a phenomenon becomes a great problem if semi-supervised learning is used by generating pseudo labels by a pre-trained model. Such a problem further results in a lethal consequence in a speech recognition algorithm using an end-to-end method, such as a transformer, with respect to time-series data such as a speech. There is a disadvantage in that error propagation occurs in view of a method of recursively performing inference by temporally using the past labels.
(Non-patent document 1) Han, B., Yao, Q., Yu, X., Niu, G., Xu, M., Hu, W., Tsang, I., Sugiyama, M.: Co-teaching: Robust training of deep neural networks with extremely noisy labels. In NeurIPS. (2018)
(Non-patent document 2) Jiang, L., Zhou, Z., Leung, T., Li, L. J., Fei-Fei, L.: Mentornet: Learning data-driven curriculum for very deep neural networks on corrupted labels. In ICML. (2018)
(Non-patent document 3) Zhang, Z., Sabuncu, M.: Generalized cross entropy loss for training deep neural networks with noisy labels. In NeurIPS. (2018)

### DISCLOSURE

### Technical Problem

Embodiments describe a speech recognition system and method for automatically correcting a data label, and more specifically, provide a technology for automatically correcting an incorrect label, among labels that are answers of data, in speech recognition for speech recognition.

Embodiments provide a speech recognition system and method for automatically correcting a data label, wherein a transformer model is constructed and the model autonomously finds and corrects an incorrect label.

Embodiments provide a speech recognition system and method for automatically correcting a data label, which can reduce a problem in that performance of a speech recognition model is deteriorated due to an incorrect label by finding and correcting the incorrect label with confidence using a transition probability between labels every decoder time step, based on a characteristic in which an answer label and an incorrect label are temporally mixed in one sentence in view of characteristics of time-series data, such as a speech.

### Technical Solution

A speech recognition method of automatically correcting a data label according to an embodiment includes performing confidence-based filtering in order to find a location at which an incorrect label has occurred in time-series speech data in which an answer label and the incorrect label have been temporally mixed by using a transformer-based speech recognition model, and improving performance of the transformer-based speech recognition model by replacing a label in a decoder time step that has been determined as the incorrect label due to the location at which the incorrect label has occurred after the filtering. In performing the confidence-based filtering in order to find the location at which the incorrect label has occurred in the time-series speech data, the incorrect label may be found and corrected by using confidence using a transition probability between labels every decoder time step.

Performing the confidence-based filtering in order to find the location at which the incorrect label has occurred in the time-series speech data may include calculating confidence by using a transition probability between labels that transition between decoder time steps, calculating confidence by using a self-attention probability that represents correlation between labels, and calculating confidence by using a source-attention probability in which a speech and correlation between labels have been considered.

Performing the confidence-based filtering in order to find the location at which the incorrect label has occurred in the time-series speech data may further include generating merged confidence by combining the confidence using a transition probability, the confidence using a self-attention probability, and the confidence using a source-attention probability, and finding the location of the incorrect label based on the merged confidence.

Improving the performance of the transformer-based speech recognition model by replacing the label in the decoder time step that has been determined as the incorrect label may include excluding a decoder time step corresponding to the incorrect label from learning with respect to the time-series speech data.

Improving the performance of the transformer-based speech recognition model by replacing the label in the decoder time step that has been determined as the incorrect label may include defining a (K+1)-th new type as a help label by adding the (K+1)-th new type to the number K of all of classification label types, and replacing the incorrect label with the help label.

Improving the performance of the transformer-based speech recognition model by replacing the label in the decoder time step that has been determined as the incorrect label may include replacing the incorrect label with a new label sampled from the transition probability.

The transformer-based speech recognition model may be a model that maps two time series having different lengths by using an attention mechanism, and may include an encoder that changes the time-series speech data into memory and a decoder that predicts a current label by using the memory and past labels.

Improving the performance of the transformer-based speech recognition model by replacing the label in the decoder time step that has been determined as the incorrect label may include performing repeatedly learning by using a Q-shot learning method in order to obtain the transition probability, the source-attention probability, the self-attention probability, and a transition probability that is used in sampling upon replacement.

A speech recognition system for automatically correcting a data label according to another embodiment includes a label filtering unit configured to perform confidence-based filtering in order to find a location at which an incorrect label has occurred in time-series speech data in which an answer label and the incorrect label have been temporally mixed by using a transformer-based speech recognition model, and a label correction unit configured to improve performance of the transformer-based speech recognition model by replacing a label in a decoder time step that has been determined as the incorrect label due to the location at which the incorrect label has occurred after the filtering. The label filtering unit may find and correct the incorrect label by using confidence using a transition probability between labels every decoder time step.

The label filtering unit may include a transition probability confidence calculation unit configured to calculate confidence by using a transition probability between labels that transition between decoder time steps, a self-attention probability confidence calculation unit configured to calculate confidence by using a self-attention probability that represents correlation between labels, a source-attention confidence calculation unit configured to calculate confidence by using a source-attention probability in which a speech and correlation between labels have been considered, a merged confidence calculation unit configured to generate merged confidence by combining the confidence using the transition probability, the confidence using the self-attention probability, and the confidence using the source-attention probability, and a label location search unit configured to find a location of an incorrect label based on the merged confidence.

### Advantageous Effects

According to embodiments, the speech recognition system and method for automatically correcting a data label, wherein a transformer model is constructed and the model autonomously finds and corrects an incorrect label, can be provided.

According to embodiments, there can be provided the speech recognition system and method for automatically correcting a data label, which can reduce a problem in that performance of a speech recognition model is deteriorated due to an incorrect label by finding and correcting the incorrect label with confidence using a transition probability between labels every decoder time step, based on a characteristic in which an answer label and an incorrect label are temporally mixed in one sentence in view of characteristics of time-series data, such as a speech.

### DESCRIPTION OF DRAWINGS

FIG. 1 is a diagram illustrating an electronic device according to an embodiment.

FIG. 2 is a block diagram illustrating a speech recognition system for automatically correcting a data label according to an embodiment.

FIG. 3 is a flowchart illustrating a speech recognition method of automatically correcting a data label according to an embodiment.

FIG. 4 is a flowchart illustrating a method of performing confidence-based filtering in order to find a location at which an incorrect label has occurred in time-series speech data according to an embodiment.

FIG. 5 is a diagram illustrating the construction of a speech recognition system for automatically correcting a label according to an embodiment.

FIG. 6 illustrates the results of a comparison between word error rates according to an embodiment.

### BEST MODE

Hereinafter, embodiments are described with reference to the accompanying drawings. However, the described embodiments may be modified in various other forms, and the scope of the present disclosure is not restricted by the following embodiments. Furthermore, various embodiments are provided to more fully describe the present disclosure to a person having average knowledge in the art. The shapes, sizes, etc. of elements in the drawings may be exaggerated for a clear description.

The following embodiments relate to a method of automatically correcting an incorrect label, among labels that are answers of data, in speech recognition for speech recognition, and more particularly, to a speech recognition method of constructing a transformer model and finding and correcting, by the model autonomously, an incorrect label.

Embodiments propose a method of finding a location of an incorrect label in time-series speech data and replacing the incorrect label with a label capable of improving performance of a speech recognition model between the ends of a transformer. The proposed method has an object of reducing an effect in that performance of a speech recognition model is deteriorated due to an incorrect label by finding and correcting the incorrect label with confidence using a transition probability between labels every decoder time step, based on a characteristic in which an answer label and an incorrect label are temporally mixed in one sentence in view of characteristics of time-series data, such as a speech.

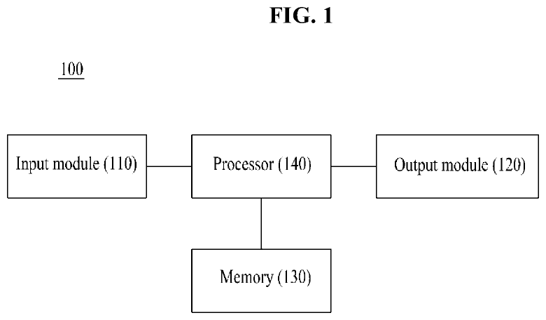

FIG. 1 is a diagram illustrating an electronic device according to an embodiment.

Referring to FIG. 1, an electronic device 100 according to an embodiment may include at least one of an input module 110, an output module 120, memory 130, or a processor 140.

The input module 110 may receive an instruction or data to be used in a component of the electronic device 100 from the outside of the electronic device 100. The input module 110 may include at least one of an input device that is constructed so that a user directly input an instruction or data to the electronic device 100 or a communication device that is constructed to receive an instruction or data through wired or wireless communication with an external electronic device. For example, the input device may include at least any one of a microphone, a mouse, a keyboard, or a camera. For example, the communication device may include at least any one of a wired communication device or a wireless communication device. The wireless communication device may include at least any one of a short-distance communication device or a long-distance communication device.

The output module 120 may provide information to the outside of the electronic device 100. The output module 120 may include at least any one of an audio output device configured to acoustically output information, a display device configured to visually output information, or a communication device configured to transmit information through wired or wireless communication with an external electronic device. For example, the communication device may include at least any one of a wired communication device or a wireless communication device. The wireless communication device may include at least any one of a short-distance communication device or a long-distance communication device.

The memory 130 may store data that is used by a component of the electronic device 100. The data may include input data or output data for a program or an instruction related to the program. For example, the memory 130 may include at least any one of volatile memory or nonvolatile memory.

The processor 140 may control a component of the electronic device 100 by executing a program of the memory 130, and may perform data processing or an operation. In this case, the processor 140 may include a label filtering unit and a label correction unit. The processor 140 may automatically correct a data label through the label filtering unit and the label correction unit.

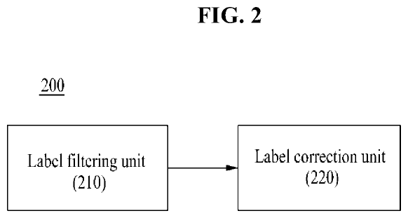

FIG. 2 is a block diagram illustrating a speech recognition system for automatically correcting a data label according to an embodiment.

Referring to FIG. 2, the speech recognition system 200 for automatically correcting a data label according to an embodiment may include a label filtering unit 210 and a label correction unit 220. In this case, the label filtering unit 210 may include a transition probability confidence calculation unit, a self-attention probability confidence calculation unit, a source-attention confidence calculation unit, a merged confidence calculation unit, and a label location search unit. The speech recognition system 200 for automatically correcting a data label may include the processor 140 in FIG. 1.

First, a transformer-based speech recognition model is a model that maps two time series having different lengths by using an attention mechanism, and may include an encoder that changes time-series speech data into memory and a decoder that predicts a current label by using the memory and the past labels.

The label filtering unit 210 may perform confidence-based filtering in order to find a location at which an incorrect label has occurred in time-series speech data in which an answer label and the incorrect label are temporally mixed by using the transformer-based speech recognition model. The label filtering unit 210 may find and correct an incorrect label with confidence using a transition probability between labels every decoder time step.

The label filtering unit 210 may include the transition probability confidence calculation unit, the self-attention probability confidence calculation unit, the source-attention confidence calculation unit, the merged confidence calculation unit, and the label location search unit.

More specifically, the label filtering unit 210 may include a transition probability confidence calculation unit that calculates confidence by using a transition probability between labels that transition between decoder time steps, a self-attention probability confidence calculation unit that calculates confidence by using a self-attention probability that represents correlation between labels, a source-attention confidence calculation unit that calculates confidence by using a source-attention probability in which a speech and correlation between labels have been considered, a merged confidence calculation unit that generates merged confidence by combining the confidence using the transition probability, the confidence using the self-attention probability, and the confidence using the source-attention probability, and a label location search unit that finds a location of an incorrect label based on the merged confidence.

The label correction unit 220 can improve performance of the transformer-based speech recognition model by replacing a label in a decoder time step that has been determined as an incorrect label due to a location at which the incorrect label has occurred after the filtering.

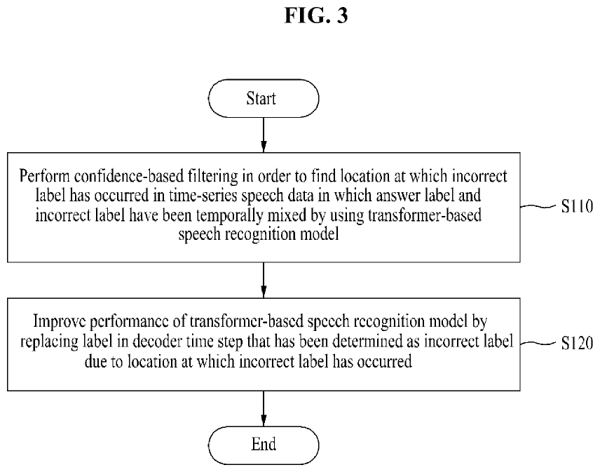

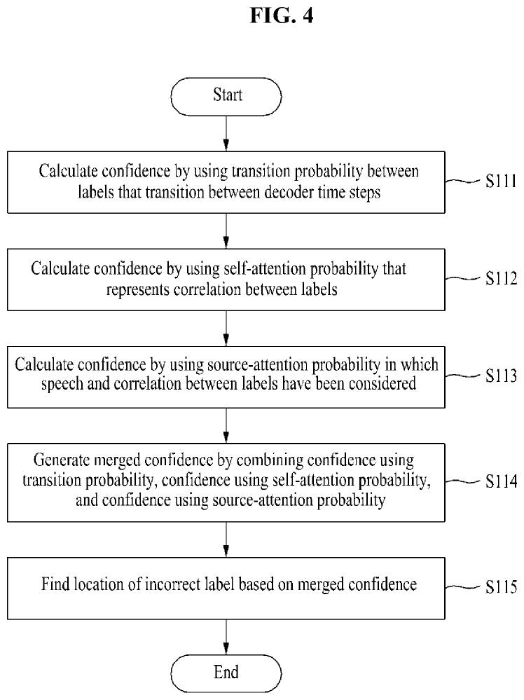

FIG. 3 is a flowchart illustrating a speech recognition method of automatically correcting a data label according to an embodiment. Furthermore, FIG. 4 is a flowchart illustrating a method of performing confidence-based filtering in order to find a location at which an incorrect label has occurred in time-series speech data according to an embodiment.

Referring to FIG. 3, the speech recognition method of automatically correcting a data label according to an embodiment includes step S110 of performing confidence-based filtering in order to find a location at which an incorrect label has occurred in time-series speech data in which an answer label and the incorrect label have been temporally mixed by using the transformer-based speech recognition model, and step S120 of improving performance of the transformer-based speech recognition model by replacing a label in a decoder time step that has been determined as the incorrect label due to the location at which the incorrect label has occurred after the filtering. In the step of performing the confidence-based filtering in order to find the location at which the incorrect label has occurred in the time-series speech data, the incorrect label may be found and corrected by using confidence using a transition probability between labels every decoder time step.

Furthermore, referring to FIG. 4, step S110 of performing the confidence-based filtering in order to find the location at which the incorrect label has occurred in the time-series speech data may include step S111 of calculating confidence by using a transition probability between labels that transition between decoder time steps, step S112 of calculating confidence by using a self-attention probability that represents correlation between labels, and step S113 of calculating confidence by using a source-attention probability in which a speech and correlation between labels have been considered.

Furthermore, the step of performing the confidence-based filtering in order to find the location at which the incorrect label has occurred in the time-series speech data may further include step S114 of generating merged confidence by combining the confidence using the transition probability, the confidence using the self-attention probability, and the confidence using the source-attention probability, and step S115 of finding the location of the incorrect label based on the merged confidence.

The steps of the speech recognition method of automatically correcting a data label according to an embodiment are described below.

The speech recognition method of automatically correcting a data label according to an embodiment may be described by taking, as an example, the speech recognition system for automatically correcting a data label according to an embodiment, which has been described with reference to FIG. 2. As described above, the speech recognition system 200 for automatically correcting a data label according to an embodiment may include the label filtering unit 210 and the label correction unit 220.

In step S110, the label filtering unit 210 may perform confidence-based filtering in order to find the location at which the incorrect label has occurred in the time-series speech data in which an answer label and the incorrect label have been temporally mixed by using the transformer-based speech recognition model. The label filtering unit 210 may find and correct the incorrect label with confidence using a transition probability between labels every decoder time step.

In this case, the label filtering unit 210 may include the transition probability confidence calculation unit, the self-attention probability confidence calculation unit, the source-attention confidence calculation unit, the merged confidence calculation unit, and the label location search unit.

In step S111, the transition probability confidence calculation unit of the label filtering unit 210 may calculate confidence by using a transition probability between labels that transition between decoder time steps.

In step S112, the self-attention confidence calculation unit of the label filtering unit 210 may calculate confidence by using a self-attention probability that represents correlation between labels.

In step S113, the source-attention confidence calculation unit of the label filtering unit 210 may calculate confidence by using a source-attention probability in which a speech and correlation between labels have been considered.

In step S114, the merged confidence calculation unit of the label filtering unit 210 may generate merged confidence by combining the confidence using the transition probability, the confidence using the self-attention probability, and the confidence using the source-attention probability.

In step S115, the label location search unit of the label filtering unit 210 may find the location of the incorrect label based on the merged confidence.

In step S120, the label correction unit 220 can improve performance of the transformer-based speech recognition model by replacing a label in a decoder time step that has been determined as the incorrect label due to the location at which the incorrect label has occurred after the filtering.

There may be proposed three replacement methods for improving performance of the model by replacing a label in a decoder time step that has been determined as the incorrect label due to the location at which the incorrect label has occurred.

For example, the label correction unit 220 may exclude a decoder time step corresponding to the incorrect label from learning in order to apply the method to the time-series speech data.

As another example, the label correction unit 220 may define a (K+1)-th new type as a help label by adding the (K+1)-th new type to the number K of all of classification label types, and may replace the incorrect label with the help label.

Furthermore, as another example, the label correction unit 220 may replace the incorrect label with a new label sampled from the transition probability.

The label correction unit 220 may be repeatedly trained by using a Q-shot learning method in order to obtain the transition probability, the source-attention probability, the self-attention probability, and a transition probability that is used in sampling upon replacement.

The speech recognition system and method for automatically correcting a data label according to an embodiment is described more specifically.

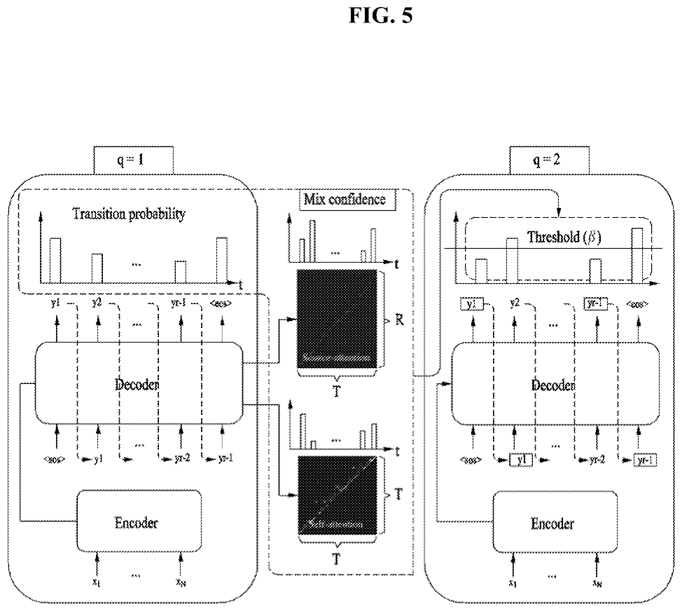

FIG. 5 is a diagram illustrating the construction of the speech recognition system for automatically correcting a label according to an embodiment.

Referring to FIG. 5, in the present embodiment, a method of correcting an incorrect label is constituted with a confidence-based filtering and replacement (CFR) method, and may include an adaptive threshold value and Q-shot learning method for each method.

First, confidence that is used to determine whether to perform confidence-based filtering is defined. Confidence may be calculated as follows by using each of the transition probability between labels that transition between decoder time steps, the source-attention probability in which a speech and correlation between labels have been considered, and the self-attention probability that represents correlation between labels, on the assumption that a probability value used is not reliable as becoming closer to a uniform distribution.

The transformer-based time-series model is a model that maps two time series having different lengths by using the attention mechanism, and a structure thereof may include the encoder that changes speech time series into memory and the decoder that predicts a current label by using the memory and the past labels. The encoder enc (.) and the decoder dec (.) are constituted with a self-attention-based neural network. The encoder converts a speech feature x into the memory h, and may be expressed as follows.

h=enc(x)

In this case, x=[x₁, X₂, . . . , x_{N}] indicates an input speech sequence having a length of N. The memory h=[h₁, h₂, h_{R}] indicates a speech-related feature. The input speech sequence is converted into the memory in a way that the length of the input speech sequence is reduced to R through sub-sampling using the encoder.

The decoder aims at a label yₜ in a decoding time step t, and a posterior probability P(y^{o}|x) may be calculated as follows.

$$P ( y ° \vert x ) = {\prod }_{i = 0}^{T} P ( {\hat{y}}_{t} = {y}_{t} \vert {{y}^{i}}_{< i} , h )$$

In this case, and P(ŷₜ=yₜ|y_{<t}ⁱ,h)=dec(y_{<t}ⁱ,h) are yₜϵC labels at a decoder index t, and C={c₁, c_{K}}.

First, the confidence using the transition probability between labels that transition between decoder time steps may be defined as follows.

$${( {σ}_{t}^{trans} )}^{2} = \frac{1}{K - 1} {\sum }_{k = 1}^{K} [ P ( {\hat{y}}_{t} = {y}_{t} \vert {y}_{< t}^{i} , h , {α}_{src} , {α}_{self} ) - \qquad [ Equation 1 ]$$

$${P ( {\hat{y}}_{t} = {c}_{k} \vert {y}_{< t}^{i} h , {α}_{src} , {α}_{self} ) ]}^{2}$$

In this case, P(ŷₜ=yₜ|y_{<t}ⁱ,h,α_{src},α_{self}) indicates a transition probability of a (noise) label yₜ in the decoder time step t, and P(ŷₜ=Cₖ|y_{<t}ⁱ,h,α_{src},α_{self}) indicates a transition probability for all of classes in the decoder time step t.

In a similar way, the confidence using the attention probability may be calculated. In this case, pieces of confidence for self-attention and source-attention may be defined as follows.

$${( {σ}_{t}^{self} )}^{2} = \frac{1}{T - 1} {\sum }_{r = 1}^{T} {[ P ( {α}_{t , {r}_{t}^{*}}^{self} \vert {y}_{< t}^{i} ) - P ( {α}_{t , r}^{self} \vert {y}_{< t}^{i} ) ]}^{2} \qquad [ Equation 2 ]$$

$${( {σ}_{t}^{self} )}^{2} = \frac{1}{R - 1} {\sum }_{τ = 1}^{R} {[ P ( {α}_{i , {τ}_{t}^{*}}^{src} \vert h , {y}_{< t}^{i} ) - P ( {α}_{τ}^{src} \vert h , {y}_{< t}^{i} ) ]}^{2} \qquad [ Equation 3 ]$$

In this case, α_{t,f}^{sell} indicates self-attention alignment with a decoder time step r in the decoder time step t, and α_{t,τ}^{src} indicates source-attention alignment with each memory time step τ in the decoder time step t.

Next, the merged confidence for simultaneously considering advantages of the three types of confidence may be expressed as in the following equation.

(σₜ^{mix})²=(1−λ)σₜ^{trans}+λ((σₜ^{src})²+(σₜ^{self})²) [Equation 4]

In this case, λϵ[0,1] is a hyper parameter.

A method of finding a location of an incorrect label based on the obtained merged confidence may be expressed as in the following equation.

mₜ=1((σₜ^{mix})²<β) [Equation 5]

In this case, β is a threshold value, and 1(·) is a threshold value. In relation to each decoder time step t, a mask obtained in this case is represented as m=[m₁, m₂, . . . , m_{T}].

There may be proposed three replacement methods for improving performance of the model by replacing a label in a decoder time step that has been determined as an incorrect label due to the obtained location.

First, a method of excluding a corresponding decoder time step from learning with respect to an incorrect label may be applied to time-series data. Second, there is a method of defining a (K+1)-th new type as a help label by adding the (K+1)-th new type to the number K of all of classification label types and replacing an incorrect label. Third, there is a method of replacing an incorrect label with a new label sampled from the transition probability.

A method for adaptively determining a threshold value that is used in the aforementioned confidence-based sampling when referring to the threshold value is introduced. To this end, first, a semi-label corruption ratio may be defined as follows by dividing, by a total decoding time, a total number of cases in which a value of a location of an incorrect label estimated in each time step within the entire decoding time is 1.

$$\hat{ζ} = \frac{{‖ {m}_{b} ‖}_{0}}{T} \qquad [ Equation 6 ]$$

In this case, ∥·∥₀ indicates a reference, that is, 0, and satisfies bϵ{1,2, . . . β}. In this case, B indicates the size of a mini-batch, and ∥m_{b}|₀ indicates the number of incorrect labels.

Data in a learning process may be adaptively updated as follows in a way that a portion having a positive value compared to a fixed label corruption ratio that has been assumed through grid search for the data is increased and that the portion is decreased in an opposite case, and may be expressed as in the following equation.

$$β ← β + \frac{1}{B} {\sum }_{b = 1}^{B} γ ( ζ - \hat{ζ} ) \qquad [ Equation 7 ]$$

In this case, a learning rate γ and a label-corruption rate ζϵ[0,1] are hyper parameters. That is, with respect to the entire decoding time T, when \hat{ζ} is greater than ζ, β is reduced, and when \hat{ζ} is smaller than \hat{ζ}, β is increased. Accordingly, \hat{ζ} and ζ follows in the learning process.

In order to obtain the three probabilities, that is, the transition probability, the source-attention probability, and the self-attention probability that are used to calculate the merged confidence, and the transition probability that is used in sampling upon replacement, the repetitive Q-shot learning method may be provided. In this case, there is a need for a probability that is obtained from the past labels for determining confidence of a given label for each decoder time step.

However, a transformer decoder having a non-autoregressive characteristic in a learning process does not sequentially calculate the three probabilities in a label in a decoder time step, and may calculate a probability for all decoder time steps through one shot. Alternatively, as the decoder is made to repeatedly perform estimation in the learning process by Q times, the decoder may calculate confidence and also perform sampling by using a probability that is obtained for the (Q−1)-th time.

Table 1 is an algorithm indicating the aforementioned Q-shot learning method.

TABLE 1
Algorithm 1 Q-short learning with CFR

| | |
|---|---|
| 1: | Speech datasets: X |
| 2: | Label datasets: Y |
| 3: | Hyperparameters: γ, λ, ζ |
| 4: | input/output_replacement_type [label excluding, proxy label, resampling] |
| 5: | Model paramenters: θ, β |
| 6: | for number of training iterations do |
| 7: | {x₁, . . . , x_{B}}~X, {y₁, . . . , y_{B}}~Y |
| 8: | for b = 1, . . . B do |
| 9: | h_{b} = enc(x_{b}) |
| 10: | for q = 1, . . . , Q do |
| 11: | if q > 1 then |
| 12: | \tilde{y}ⁱ, \tilde{y}⁰, m_{b} = CFR(β, γ, λ, input/output_replacement_type, dec(y_{<t}¹, h_{b})) |
| 13: | y_{b}ⁱ = stopGrad(\tilde{y}ᵢ [:−1]), y_{b}⁰ = stopGrad(\tilde{y}⁰ [:−1]) |
| 14: | end if |
| 15: | yⁱ = concat([<sos>], y_{b}¹), y⁰ = concat(y_{b}⁰, [<eos>]) |
| 16: | P(y⁰x_{b}) = Πₜ₌₁^{T} P(ŷ₁ = y₁ \|y_{<1}¹, h_{b}, α_{src}, α_{self})P(α_{src}\| h_{b}, y_{<1}¹)P(α_{self} \| y_{<1}¹) |
| 17: | end for |
| 18: | end for |
| 19: | $L ( θ ) = - \frac{1}{B} {\sum }_{b = 1}^{B} log P ( {y}_{b} \vert {x}_{b} )$ |
| 20: | $Update θ ← Adam ( θ , \frac{\partial L}{\partial θ} )$ |
| 21: | $Update β ← β + \frac{1}{B} {\sum }_{b = 1}^{B} γ ( ζ - {‖ {m}_{b} ‖}_{0} / T )$ |
| 22: | end for |

-

A label replacement method is described in more detail.

There may be proposed three alternative methods for improving performance of the model by replacing a label that is considered as an incorrect label due to a mask in the decoder time step t.

First, a label exclusion method of excluding the decoder time step t of an incorrect label during learning may be used to deactivate back-propagation based on the incorrect label.

Second, in a proxy label method, a new (K+1)-th class c_{K+1} may be added to the entire class set C={c₁, . . . , c_{K}}. This may be defined as a proxy label and replace an incorrect label. This may be represented as follows.

ŷ=Cₖ₊₁

In this case, \tilde{y} is a label that replaces the incorrect label. The class may model an exception label. This can reduce a phenomenon in which a decision boundary estimated by the transformer model has been excessively twisted because a distance from the decision boundary is far.

Third, a resampling method is used to sample a label \tilde{y} from a polynomial expression transition probability rather than taking argmax. This may be expressed as follows.

\tilde{y}˜P(Cₜ|y_{<t}ⁱ,h,α_{src},α_{self})

In this case, Cₜ indicates all the classes Cₜ={c1, . . . , c_{K}} in the decoder time step t. An advantage of this method is that the model can find a label (e.g., a label having the second or third highest probability value) other than a label having the highest probability.

Accordingly, a kind of advantage attributable to a normalization effect similar to the second method and the Moire diversity of a label is that another label other than a label having argmax can be found through Q-time inference.

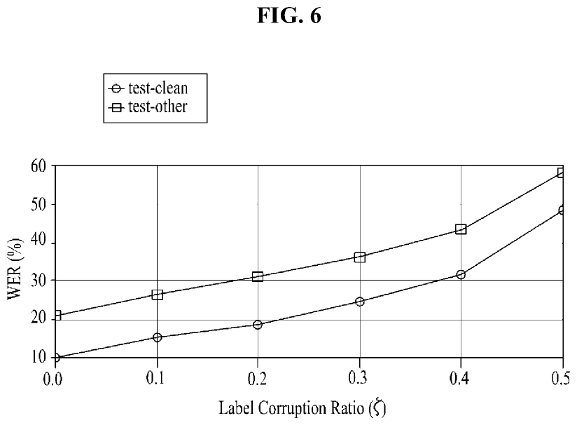

FIG. 6 illustrates the results of a comparison between word error rates according to an embodiment.

In order to research each of the aforementioned methods, experiments were performed on performance of a reference line and performance deterioration attributable to a label having noise. FIG. 6 illustrates the results of a comparison between word error rates (WER). If 40% of s-train-100 is an incorrect label (a label case in which severe noise is present), the word error rate (WER) is suddenly increased.

According to embodiments, a label corruption problem in sequential data can be reduced, and performance of simulations and a semi-supervised learning task can be improved. Such results may be checked through confidence that is obtained in the transformer while a location of an incorrect label is learnt. Furthermore, performance that is obtained by using sampling and a proxy label is similar to that of the model using an Oracle dataset. In this method, a test dataset may be optimized by using an assumed label corruption ratio and an adaptive threshold value.

As described above, embodiments have an object of solving a phenomenon in which performance is deteriorated due to an incorrect label in time-series data, such as a speech, and propose the method of replacing a location at which the incorrect label has occurred with a label that may help learning after confidence-based filtering in order to find the location at which the incorrect label has occurred. Furthermore, performance of a test dataset can be optimized by adaptively calculating a threshold value that determines whether to perform confidence-based filtering by using a label corruption ratio, that is, the number of incorrect labels of a learning dataset. Additionally, there is proposed the Q-shot learning method for calculating a probability that is necessary for the calculation and replacement of confidence.

The speech recognition system according to embodiments enables advanced speech recognition by reducing a label corruption problem that deteriorates performance of speech recognition due to an incorrect label in a way to correcting the incorrect label by using the confidence-based filtering and replacement method.

The aforementioned device may be implemented as a hardware component, a software component, or a combination of a hardware component and a software component. For example, the device and component described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing or responding to an instruction. The processing device may perform an operating system (OS) and one or more software applications that are executed on the OS. Furthermore, the processing device may access, store, manipulate, process, and generate data in response to the execution of software. For convenience of understanding, one processing device has been illustrated as being used, but a person having ordinary knowledge in the art may understand that the processing device may include a plurality of processing elements and/or a plurality of types of processing elements. For example, the processing device may include a plurality of processors or one processor and one controller. Furthermore, another processing configuration, such as a parallel processor, is also possible.

Software may include a computer program, a code, an instruction or a combination of one or more of them, and may configure a processing device so that the processing device operates as desired or may instruct the processing devices independently or collectively. The software and/or the data may be embodied in any type of machine, a component, a physical device, virtual equipment, or a computer storage medium or device in order to be interpreted by the processing device or to provide an instruction or data to the processing device. The software may be distributed to computer systems that are connected over a network, and may be stored or executed in a distributed manner. The software and the data may be stored in one or more computer-readable recording media.

The method according to an embodiment may be implemented in the form of a program instruction executable by various computer means and stored in a computer-readable medium. The computer-readable recording medium may include a program instruction, a data file, and a data structure solely or in combination. The program instruction recorded on the medium may be specially designed and constructed for an embodiment, or may be known and available to those skilled in the computer software field. Examples of the computer-readable recording medium include magnetic media such as a hard disk, a floppy disk and a magnetic tape, optical media such as CD-ROM and a DVD, magneto-optical media such as a floptical disk, and hardware devices specially configured to store and execute a program instruction, such as ROM, RAM, and a flash memory. Examples of the program instruction include a high-level language code executable by a computer by using an interpreter in addition to a machine-language code, such as that written by a compiler.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned components, such as a system, a structure, a device, and a circuit, are coupled or combined in a form different from that of the described method or replaced or substituted with other components or equivalents thereof.

Accordingly, other implementations, other embodiments, and the equivalents of the claims fall within the scope of the claims.

1. A speech recognition method of automatically correcting a data label, the method comprising:
performing confidence-based filtering in order to find a location at which an incorrect label has occurred in time-series speech data in which an answer label and the incorrect label have been temporally mixed by using a transformer-based speech recognition model; and
improving performance of the transformer-based speech recognition model by replacing a label in a decoder time step that has been determined as the incorrect label due to the location at which the incorrect label has occurred after the filtering,
wherein in performing the confidence-based filtering in order to find the location at which the incorrect label has occurred in the time-series speech data, the incorrect label is found and corrected by using confidence using a transition probability between labels every decoder time step.

2. The speech recognition method of claim 1, wherein performing the confidence-based filtering in order to find the location at which the incorrect label has occurred in the time-series speech data comprises:
calculating confidence by using a transition probability between labels that transition between decoder time steps;
calculating confidence by using a self-attention probability that represents correlation between labels; and
calculating confidence by using a source-attention probability in which a speech and correlation between labels have been considered.

3. The speech recognition method of claim 2, wherein performing the confidence-based filtering in order to find the location at which the incorrect label has occurred in the time-series speech data further comprises:
generating merged confidence by combining the confidence using a transition probability, the confidence using a self-attention probability, and the confidence using a source-attention probability; and
finding the location of the incorrect label based on the merged confidence.

4. The speech recognition method of claim 1, wherein improving the performance of the transformer-based speech recognition model by replacing the label in the decoder time step that has been determined as the incorrect label comprises excluding a decoder time step corresponding to the incorrect label from learning with respect to the time-series speech data.

5. The speech recognition method of claim 1, wherein improving the performance of the transformer-based speech recognition model by replacing the label in the decoder time step that has been determined as the incorrect label comprises
defining a (K+1)-th new type as a help label by adding the (K+1)-th new type to the number K of all of classification label types, and
replacing the incorrect label with the help label.

6. The speech recognition method of claim 1, wherein improving the performance of the transformer-based speech recognition model by replacing the label in the decoder time step that has been determined as the incorrect label comprises replacing the incorrect label with a new label sampled from the transition probability.

7. The speech recognition method of claim 1, wherein the transformer-based speech recognition model is a model that maps two time series having different lengths by using an attention mechanism, and comprises an encoder that changes the time-series speech data into memory and a decoder that predicts a current label by using the memory and past labels.

8. The speech recognition method of claim 2, wherein improving the performance of the transformer-based speech recognition model by replacing the label in the decoder time step that has been determined as the incorrect label comprises performing repeatedly learning by using a Q-shot learning method in order to obtain the transition probability, the source-attention probability, the self-attention probability, and a transition probability that is used in sampling upon replacement.

9. A speech recognition system for automatically correcting a data label, comprising:
a label filtering unit configured to perform confidence-based filtering in order to find a location at which an incorrect label has occurred in time-series speech data in which an answer label and the incorrect label have been temporally mixed by using a transformer-based speech recognition model; and
a label correction unit configured to improve performance of the transformer-based speech recognition model by replacing a label in a decoder time step that has been determined as the incorrect label due to the location at which the incorrect label has occurred after the filtering,
wherein the label filtering unit finds and corrects the incorrect label by using confidence using a transition probability between labels every decoder time step.

10. The speech recognition system of claim 9, wherein the label filtering unit comprises:
a transition probability confidence calculation unit configured to calculate confidence by using a transition probability between labels that transition between decoder time steps;
a self-attention probability confidence calculation unit configured to calculate confidence by using a self-attention probability that represents correlation between labels;
a source-attention confidence calculation unit configured to calculate confidence by using a source-attention probability in which a speech and correlation between labels have been considered;
a merged confidence calculation unit configured to generate merged confidence by combining the confidence using the transition probability, the confidence using the self-attention probability, and the confidence using the source-attention probability; and
a label location search unit configured to find a location of an incorrect label based on the merged confidence.
